(19) United States
(12) Patent Application Publication
(10) Pub. No.: US 2017/0325033 A1
(43) Pub. Date: Nov. 9, 2017

(54) METHOD FOR OPERATING A HEARING DEVICE, HEARING DEVICE AND COMPUTER PROGRAM PRODUCT

(71) Applicant: SIVANTOS PTE. LTD., SINGAPORE (SG)

(72) Inventors: MARC AUBREVILLE, NUERNBERG (DE); HENNING PUDER, ERLANGEN (DE); MICHAEL DORNER, NEUMARKT (DE)

(21) Appl. No.: 15/590,173

(22) Filed: May 9, 2017

(30) Foreign Application Priority Data
May 9, 2016 (DE) 102016207936.0

(51) Int. Cl. H04R 25/00; H04M 1/60; H04M 1/247; H04M 1/725

(52) U.S. Cl. CPC H04R 25/505; H04R 25/43; H04M 1/6016; H04M 1/72591; H04M 1/2475; H04R 25/554; H04R 25/00; H04R 2225/41; H04R 2225/49; H04R 2499/11

(57) ABSTRACT

A method operates a hearing device, in which an adaptation to the hearing device by a hearing device wearer is determined. An ambient situation is detected, and a value is assigned to the ambient situation. The value is used as a degree of adaptation. A hearing device includes a microphone for detecting the ambient situation and a hearing device system includes a hearing device, as well as the use of a hearing device and a computer program product.

### CROSS-REFERENCE TO RELATED APPLICATION

This application claims the priority, under 35 U.S.C. §119, of German application DE 10 2016 207 936.0, filed May 9, 2016; the prior application is herewith incorporated by reference in its entirety.

### BACKGROUND OF THE INVENTION

### Field of the Invention

The present invention relates to a method for operating a hearing device, and to a hearing device including a microphone. The method furthermore relates to a hearing device system including such a hearing device, to a use of a hearing device, and to a computer program product.

Persons who suffer from a reduction in hearing ability generally use a hearing aid device. In this case, ambient sound is generally detected by an electromechanical sound transducer. The detected electrical signals are processed by an amplifier circuit and are introduced into the auditory canal of the person by another electromechanical transducer. Various kinds of hearing aid devices are known. The so-called “behind-the-ear devices” are worn between the skull and the auricle. In this case, the introduction of the amplified sound signal into the auditory canal takes place by use of a sound tube. An additional commonly used design of a hearing aid device is an “in-the-ear device,” in which the hearing aid device itself is introduced into the auditory canal. By means of this hearing aid device, the auditory canal is thus at least partially closed, so that other than the sound signals generated by the hearing aid device, no other sound, or only sound at a greatly reduced level, is able to enter the auditory canal.

The onset of hearing loss which is compensated for by a hearing aid device is usually gradual; therefore, the brain unlearns how to process certain acoustic stimuli. As soon as a hearing aid device is used, the hearing device wearer again detects the acoustic stimuli, but is not able to associate it correctly. As a result, acceptance of the hearing aid device is reduced.

It is also simply difficult for the hearing device wearer to verify the degree to which an improvement in the adaptation, and thus improved processing of acoustic stimuli, has already occurred due to the use of the hearing aid device for a longer period of time.

### SUMMARY OF THE INVENTION

The object of the present invention is to provide a particularly suitable method for operating a hearing device and a particularly suitable hearing device, and a particularly suitable hearing device system including a hearing device, and a particularly suitable use of a hearing device, as well as a particularly suitable computer program product, wherein in particular acceptance by a hearing device wearer is increased.

The method for operating a hearing device is used for determining an adaptation to the hearing device by a hearing device wearer. In particular, a modified use behavior by the hearing device wearer is determined. The method is thus suitable and provided for determining an adaptation to the hearing device by the hearing device wearer. For example, the hearing device is an earphone or contains an earphone. However, particularly preferably, the hearing device is a hearing aid device. The hearing aid device is used for assisting a person suffering from a reduction in hearing ability. In other words, the hearing aid device is a medical device by which, for example, a partial hearing loss is compensated for. The hearing aid device is, for example, a receiver-in-the-canal hearing aid device (RIC; formerly, earpiece hearing aid device), an in-the-ear hearing aid device, an in-the-canal hearing aid device (ITC), or a complete-in-canal hearing aid device (CIC), hearing aid glasses, a pocket hearing aid device, a bone-conduction hearing aid device, or an implant. Particularly preferably, the hearing aid device is a behind-the-ear hearing aid device which is worn behind an auricle. If the hearing device is a hearing aid device, it is in particular possible to determine by the method whether a discrimination loss or an auditory deprivation is reduced.

The method provides that an ambient situation is detected, the detection taking place in particular by the hearing device. For this purpose, advantageously, an audio signal is initially detected, and based on the audio signal, the detection of the ambient situation takes place, for which purpose the audio signal is preferably suitably evaluated. A value is assigned to the ambient situation. When assigning the value to the ambient situation, for example, only the ambient situation itself is considered. However, particularly preferably, other factors are considered when assigning the value. In particular, the assignment takes place based on a formula or a characteristic map which is preferably created based on statistical information. In this case, for example, correlations are also considered in addition, wherein a certain correlation factor or a correlation function is assigned to the ambient situation and to an additional piece of information. For example, the value range for the possible values is limited. Advantageously, the value range is limited to a range between zero (0) and one (1), or a range between 0% and 100%. In an alternative thereto, for example, the value may assume a number of discrete steps, for example, 1, 2, . . . 5, 6. In another alternative, the value corresponds to a particular word. For example, the ambient situation is classified according to particular criteria, and a certain value or value range for the value is assigned to each of these classes.

The value which was assigned to the ambient situation is used as a degree of adaptation. In other words, the value denotes the extent to which the hearing aid wearer is adapted to the hearing device. For example, 100% denotes a value of complete adaptation, whereas 0% essentially denotes no adaptation to the hearing device. In summary, the degree of adaptation is determined based on the ambient situation and as a function thereof, wherein this takes place independently of any learning programs or the like. In other words, any arbitrary ambient situation which has been detected is used for determining the degree of adaptation.

On the basis of the value, the hearing aid wearer is encouraged to seek out or manage such ambient situations which are associated with a high degree of adaptation. As a result, an actual adaptation and use of the hearing device by the hearing aid wearer increases, and acceptance of the hearing device by the hearing aid wearer is increased. It is also possible for the hearing aid wearer to determine the extent to which a learning process and thus an adaptation to the hearing device has already occurred or has been accomplished, so that positive feedback and thus encouragement is provided by the value. The hearing aid wearer is also able to compare the value with the values of other hearing aid wearers, and thus to compare adaptation progress with other hearing aid wearers in a qualitative and preferably quantitative manner. By means of the method, in particular using the degree of adaptation/the value, an auditory capability of the hearing aid wearer is suitably determined. For example, the method is used for determining the auditory capability of the hearing aid wearer.

Preferably, the method is at least partially computer-implemented. For this purpose, a signal processor of the hearing device is preferably suitably programmed and/or has a suitable memory for functions for carrying out the method steps.

For example, when assigning the value to the ambient situation, a temporally preceding value which was assigned to a temporally preceding ambient situation is considered. In other words, the temporally preceding ambient situation is an additional parameter, on the basis of which the value is determined. Advantageously, in this case, the current ambient situation is evaluated in comparison to the preceding ambient situation. In particular, the directly temporally preceding value/the directly temporally preceding ambient situation is used. Preferably, the generated value is considered when assigning the new value, even during renewed execution of the method. Particularly preferably, a number of such values, and thus a number of such ambient situations, are considered during the assignment of the value. As a result, the extent to which the ambient situation changes or has changed is considered, thus permitting a further conclusion to be drawn with respect to the adaptation. In other words, it is considered whether the hearing device user prefers certain ambient situations, or whether a preference changes. A conclusion is thereby drawn with respect to the degree of adaptation.

Particularly preferably, during the assignment of the value to the ambient situation, the time interval from the temporally preceding value is considered. Preferably, the degree of adaptation is increased if the time interval is reduced. In other words, the degree of adaptation is inversely proportional to the time interval. For example, in this case as well, a number of such values and the respective time interval are used when assigning the value to the ambient situation. Advantageously, an auxiliary value is generated which describes the number of such ambient situations within a certain time window. If the auxiliary value is greater, the value is also increased.

It is particularly preferable to compare the value with the temporally preceding value, for example, with a number of such values. In this way, it is possible for the hearing device user to check whether the degree of adaptation has increased or decreased since the temporally preceding value was generated.

Preferably, the value is output by an output device, taking place, for example, acoustically or graphically. If the hearing device itself has no such output device, the value is preferably transmitted to the output device. For this purpose, the hearing device has, for example, a communication device which is suitably operated. In other words, preferably, a data signal, in particular a radio signal, is generated, which is transmitted to an output device or a device including the output device. In this way, it is comparatively easy for hearing device users to check their degree of adaptation. Preferably, in addition, the temporally preceding value, or a number of such temporally preceding values, are also output by the output device. In this way, the time profile of the user's degree of adaptation is communicated to the hearing device user, resulting in additional encouragement.

For example, the hearing device wearer's speech is used as an ambient situation. In other words, it is detected how often the hearing device wearer speaks, and an absolute time measure is determined. Alternatively or in combination thereto, as an ambient parameter, participation in a conversation is used as an ambient situation. In other words, a relative time measure is used as an ambient situation, wherein this, for example, is determined by percentage, i.e. the percentage to which the hearing device wearer influences the conversation. If the hearing device is a hearing aid device, it is thus checked to what extent the hearing device wearer actively participates in a conversation, and whether the hearing device wearer is involved in conversational situations such as discussions, etc. If the hearing device wearer wears the hearing aid device only after the onset of a loss of discrimination or an auditory deprivation, it is possible that the hearing device wearer receives the acoustic signals by the hearing aid device, but is not able to associate or process them correctly due to the brain having become unaccustomed to such acoustic signals. As a result, participation in a conversation and speaking as such are usually reduced. The greater the adaptation to the hearing device is, thus corresponding to renewed learning by the brain, the more the hearing device wearer participates both actively and passively in conversations. In other words, the hearing device wearer interacts with others to a greater extent. These ambient situations are thus detected and used as a degree of adaptation. In this case, in addition, a time interval from temporally preceding ambient situations is preferably considered, i.e., how often the hearing device wearer participates in such conversations. The greater this number is, the higher the degree of adaptation.

Alternatively or particularly preferably in combination thereto, a measure of background noise is used as an ambient situation. In other words, background noise, as well as a measure thereof, is initially determined. In summary, the presence of background noise is initially detected, and a measure is assigned to it. A value is assigned to the measure. In particular, the value is increased if the level of background noise is also increased. In other words, an increased value is assigned to a comparatively loud environment. When determining the level of the background noise, it is, for example also determined whether the background noise has a musical or human origin. The more challenging the background noise is, the higher in particular the value is. In other words, it is checked whether the hearing device user is exposed to audiologically challenging situations. If this is the case, the value, and thus the degree of adaptation, is preferably increased. In particular, if the values are compared, the hearing device wearer is encouraged to engage in acoustically challenging environments, thereby training the wearer's brain and thus increasing the adaptation to the hearing device and the acceptance of the hearing device.

The hearing device contains a microphone, i.e., an electromechanical sound transducer. By use of the microphone, in particular audio signals are detected during operation. The microphone is used for detecting an ambient signal, for which purpose, for example, the audio signal is evaluated by a signal processor and/or a signal processing unit. The hearing device is suitable, as well as provided and configured, for carrying out a method for determining an adaptation to the hearing device by a hearing device wearer, wherein in particular modified user behavior of the hearing device wearer is determined. The method is thus suitable and provided for determining an adaptation to the hearing device by the hearing device wearer. The method provides that an ambient situation is detected by means of the hearing device, wherein, for example, the ambient signal is evaluated. Furthermore, a value is assigned to the ambient situation, and the value is used as a degree of adaptation.

The hearing device preferably contains an amplifier circuit by which the audio signal may be amplified. Preferably, the hearing device contains an actuator by which a sound signal is generated, as well as a loudspeaker which is suitable and, for example, provided and configured, for outputting the amplified audio signal. For example, the hearing device is an earphone or contains an earphone. However, particularly preferably, the hearing device is a hearing aid device. The hearing aid device is used for assisting a person suffering from a reduction in hearing ability. In other words, the hearing aid device is a medical device by which, for example, a partial hearing loss is compensated for. The hearing aid device is, for example, a receiver-in-the-canal hearing aid device (RIC; formerly, earpiece hearing aid device), an in-the-ear hearing aid device, an in-the-canal hearing aid device (ITC), or a complete-in-canal hearing aid device (CIC), hearing aid glasses, a pocket hearing aid device, a bone-conduction hearing aid device, or an implant. Particularly preferably, the hearing aid device is a behind-the-ear hearing aid device which is worn behind an auricle.

The hearing device is provided and configured to be worn on the human body. In other words, the hearing device preferably contains a support device by which attachment to the human body is possible. If the hearing device is a hearing aid device, the hearing device is provided and configured, for example, to be arranged behind the ear or inside an auditory canal. In particular, the hearing device is wireless, and is provided and configured to be at least partially inserted into an auditory canal. For example, the hearing device is a component of a hearing device system which contains another hearing device or another device, such as a directional microphone or another device including a microphone. In this case, the device preferably contains the transmitter and the hearing device contains the receiver, and the transmission of the audio signal between the transmitter and the receiver takes place according to the method.

The hearing device system contains a hearing device which is provided and configured to be operated according to the above method. Furthermore, the hearing device system includes a smart phone having an output device. The smart phone is, for example, a cell phone or a tablet PC. The hearing device and the smart phone are coupled via signaling technology, for example, wirelessly, in particular inductively or by means of radio such as Bluetooth or WLAN, or by means of a cable. Based on the coupling via signaling technology, it is possible to exchange signals, in particular data, between the smart phone and the hearing device. When the method is carried out, the ambient situation is detected in particular by the hearing device. For example, the value of the ambient situation is assigned by the hearing device. Alternatively, data corresponding to the detected ambient situation are transmitted to the smart phone, by which the value is assigned to the ambient situation. The value is output by the smart phone, for which purpose the output device of the smart phone is used. In particular, the value is graphically depicted.

Particularly preferably, the hearing device system is a hearing aid system. The hearing aid system is used for assisting a person suffering from loss of hearing ability. In other words, the hearing aid system is a medical device by which, for example, a partial hearing loss is compensated for. The hearing aid system advantageously contains a behind-the-ear hearing aid device, which is worn behind the auricle, a receiver-in-the-canal hearing aid device (RIC; formerly, earpiece hearing aid device), an in-the-ear hearing aid device, an in-the-canal hearing aid device (ITC), or a complete-in-canal hearing aid device (CIC), hearing aid glasses, a pocket hearing aid device, a bone-conduction hearing aid device, or an implant. The hearing device system is in particular provided and configured to be worn on the human body. In other words, the hearing device system preferably contains a support device by which attachment to the human body is made possible. In particular, the hearing device system is wireless, and is provided and configured to be at least partially inserted into an auditory canal. Particularly preferably, the hearing device system contains an energy storage device by which an energy supply is provided.

The hearing device is in particular used to carry out a method for determining an adaptation to the hearing device by a hearing device wearer, in which an ambient situation is detected by the hearing device. Furthermore, a value is assigned to the ambient situation, and the value is used as a degree of adaptation. The hearing device is used as a sensor for detecting an adaptation by a hearing device wearer, for which purpose the above method is advantageously carried out.

The computer program product contains a computer-readable storage medium which, for example, is a non-writable memory (ROM memory) or a flash memory. For example, the storage medium is integrated inside a smart phone or a hearing device. Computer-readable program code is contained in the storage medium and, for example, is written in a particular programming language or assembler language. The computer-readable program code contains instructions which carry out a method for determining an adaptation to a hearing device by a hearing device wearer. Here, the method contains the following steps: detecting an ambient situation, assigning a value to the ambient situation, and using the value as a degree of adaptation. In particular, the computer program product is executable on a signal processor, in particular a digital signal processor (DSP), or a processor of a smart phone. The computer program product is programmed for carrying out the method if the computer program runs on the processor, i.e., on the computing device.

The refinements and advantages described with respect to the method are analogously also to be transferred to the hearing device or the hearing device system/the computer program product, and vice-versa.

Other features which are considered as characteristic for the invention are set forth in the appended claims.

Although the invention is illustrated and described herein as embodied in a method for operating a hearing device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic illustration of a hearing device;

FIG. 2 is a flow chart depicting a method for operating the hearing device according to the invention;

FIG. 3 is a block diagram of a hearing device system including the hearing device and a smart phone; and

FIG. 4 is an illustration of the smart phone.

### DETAILED DESCRIPTION OF THE INVENTION

Corresponding parts are provided with the same reference numerals in all figures.

Referring now to the figures of the drawings in detail and first, particularly to FIG. 1 thereof, there is shown a hearing device system 2 including a hearing aid device 4, which is provided and configured to be worn behind the ear of a hearing device wearer. In other words, it relates to a behind-the-ear hearing aid device which has a sound tube which is not depicted and which is inserted into the ear. The hearing aid device 4 contains a housing 6 which is made of a plastic. A microphone 8 having two electromechanical sound transducers 10 is arranged inside the housing 6. The two electromechanical sound transducers 10 make it possible to change a directional characteristic of the microphone 8, in that a time offset between the acoustic signals detected by the respective electromechanical sound transducer 10 is changed. The two electromechanical sound transducers 10 are coupled via signaling technology with a signal processing unit 12 which contains an amplifier circuit. The signal processing unit 12 is formed by circuit elements, for example, electrical and/or electronic components.

Furthermore, a loudspeaker 14 is coupled via signaling technology with the signal processing unit 12, by means of the loudspeaker the audio signals picked up via the microphone 8 and/or processed by the signal processing unit 12 are output as sound signals. These sound signals are conducted by a sound tube, which is not depicted in greater detail, into the ear of the hearing device wearer of the hearing device system 2. The hearing aid device furthermore includes a communication device 16 by which an exchange of data signals 18 takes place. The exchange takes place, for example, by radio or inductively.

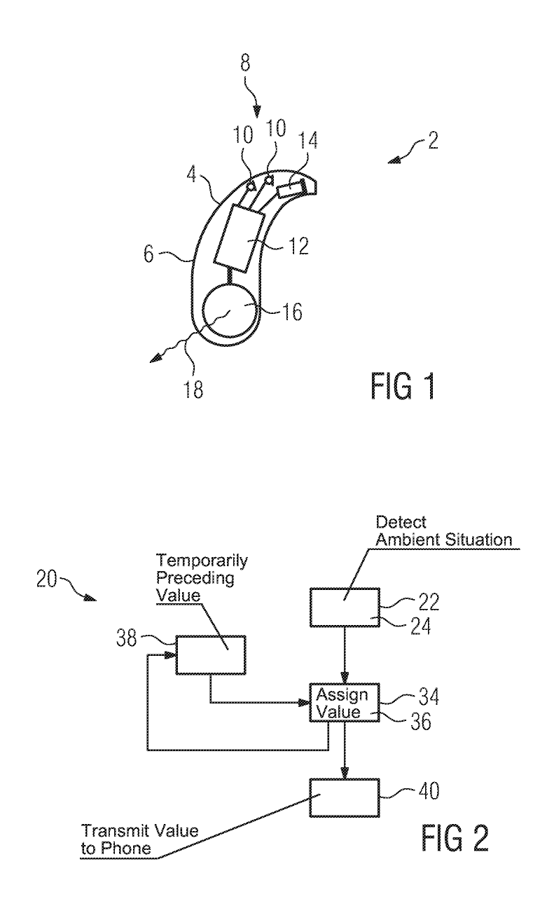

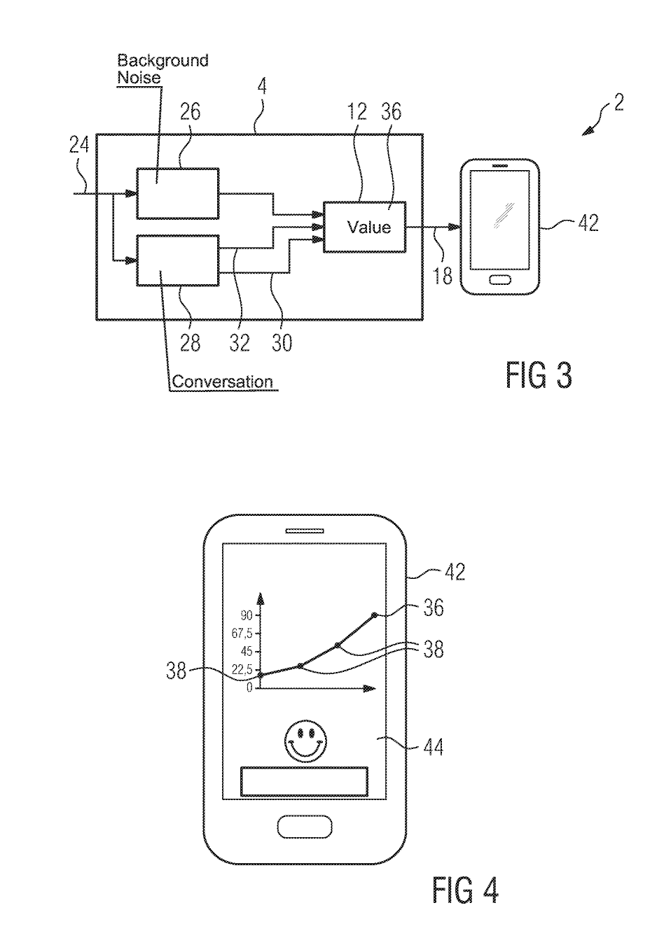

FIG. 2 shows a method 20 for operating the hearing aid device 4 and the hearing device system 2, in which an adaptation to the hearing aid device 4 by the hearing device wearer is determined. In a first process step 22, an ambient situation 24 is detected, for which purpose the microphone 8 and the signal processing unit 12 are used. For this purpose, an audio signal is detected by the microphone 8, and the ambient situation 24 is identified within the audio signal by the signal processing unit 12. As shown in FIG. 3, the ambient situation 24 is classified, namely, on the one hand, as to whether the ambient situation 24 is a measure of background noise 26. For this purpose, the audio signal is initially analyzed to determine whether background noise is present, i.e., as to whether background noise exists qualitatively. Furthermore, the background noise is quantitatively evaluated. In this case, the background noise is, for example, caused by traffic or by a musical piece. On the other hand, classification is used to determine whether the audio signal is a conversation 28, and in this case, whether the hearing device wearer's own speech 30 is involved. For this purpose, the voice of the hearing device wearer is determined within the audio signal, and the time duration of the speech is measured. Furthermore, during the conversation 28, participation 32 by the hearing device wearer in the conversation 28 is determined and is used as an ambient situation 24. The extent to which the hearing device wearer actively participates in the conversation 28 is evaluated by percentage.

In a second process step 34, a value 36 is assigned to the ambient situation 24 by the signal processing unit 12. For example, a characteristic map having multiple parameters is used, wherein one of the parameters is the ambient situation 24 itself. In this case, the value 36 is stored in the characteristic map as a degree of adaptation, wherein the parameters are carried out for determining the value 36 or the degree of adaptation. In other words, the value 36 is used as the degree of adaptation. Another parameter is a temporally preceding value 38. The temporally preceding value 38 was determined during a preceding execution of the method 20 as a value 36. During initialization of the hearing device 4, the temporally preceding value 38 is, for example, zero. Furthermore, the time interval between the value 36 and the temporally preceding value 38 is used as a parameter, i.e., the amount of time which has elapsed since the temporally preceding ambient situation 24 was detected. In particular, during the assignment of the value 36 to the ambient situation 24, a plurality of preceding values 38 is used, the values, and consequently their respective corresponding ambient situation, differing based on the distance from the ambient situation 24.

In a subsequent, third process step 40, the value 36 is transmitted by a data signal 18 to a smart phone 42 which is coupled via signaling technology to the hearing device 4 and is a component of the hearing device system 2. Furthermore, by means of the data signal 18, all temporally preceding values 38, or at least a number, for example, four, of such temporally preceding values 38, or temporally preceding values 38 which have a particular, in particular constant, time interval from the value 36, are transmitted to the smart phone 42. After the value 36 has been assigned and transmitted to the smart phone 42, it is used as the directly temporally preceding value 38.

As depicted in FIG. 4, the value 36 and the temporally preceding values 38 are output, or a number of such temporally preceding values 38 are output, by means of an output device 44 of the smart phone 42 such as a display, wherein the temporally preceding value 38 is compared to the value 36. Based on the comparison, the hearing device wearer is able to comprehend an improvement in the degree of adaptation, so that information with respect to the wearer's adaptation to the hearing device 4, and consequently to the wearer's “hearing fitness,” is provided to the hearing device wearer by the output device 44.

Based on the use of statistical data when ascertaining the value 36, and based on the detection of the ambient situation 24, and based on the comparison with temporally preceding values 38, the hearing device wearer obtains positive feedback in order to adapt to the hearing device 4, and as a result, to be able to comprehend whether there is a renewed improvement in hearing. This increases acceptance of the hearing device system 2. In particular, due to changes in the brain, hearing may be impaired even if the amplified audio signals are provided, in particular if the hearing device wearer begins using the hearing device system 2 only after the hearing impairment is already relatively highly advanced. The degree of adaptation is estimated by means of the method 20, wherein a direct connection between improved hearing, and consequently an increased degree of adaptation, and interaction with other people is assumed. Thus, there is an increased adaptation in the case of a higher level of participation in conversations 28, both actively and passively.

The method 20 also assumes that the hearing device wearer seeks out environments having an increased level of background noise 26, for example, concerts, which are audiologically challenging. In summary, in particular based on the parameters, the value 36 is calculated for how often the voice activity of the hearing device wearer is measured, i.e., how often the wearer actively participates in a conversation 28. The situation of the conversation 28 is also classified, i.e., how often the hearing device wearer is involved in the conversation 28, i.e., the wearer's participation 32. Furthermore, for determining the degree of adaptation, it is considered how often the hearing device wearer seeks out acoustically challenging situations or is situated in them. The value 36 and the temporally preceding values 38 therefore form a score, which thus reflects the performance of the hearing device wearer, and thus represents the wearer's degree of adaptation in a qualitatively and quantitatively comprehensible manner. As a result, the hearing device wearer is more strongly motivated, and acceptance of the hearing device 4 and of the hearing device system 2 by the wearer is improved.

The present invention is not limited to the exemplary embodiment described above. Rather, other variants of the present invention may be derived from them by those skilled in the art, without departing from the subject matter of the present invention. In particular, all individual features described in connection with the exemplary embodiment may furthermore also be combined with one other in a different manner without departing from the subject matter of the present invention.

The following is a summary list of reference numerals and the corresponding structure used in the above description of the invention:
2 Hearing device system
4 Hearing aid device
6 Housing
8 Microphone
10 Sound transducer
12 Signal processing unit
14 Loudspeaker
16 Communication device
18 Data signal
20 Method
22 process step
24 Ambient situation
26 Level of background noise
28 Conversation
30 Speech
32 Participation
34 Second process step
36 Value
38 Temporally preceding value
40 Third process step
42 Smartphone
44 Output device

1. A method for operating a hearing device, in which an adaptation to the hearing device by a hearing device wearer is determined, which comprises the steps of:
detecting an ambient situation;
assigning a value to the ambient situation; and
using the value as a degree of adaptation.

2. The method according to claim 1, wherein during an assignment of the value to the ambient situation, a temporally preceding value which was assigned to a temporally preceding ambient situation is considered.

3. The method according to claim 2, wherein during the assignment of the value to the ambient situation, a time interval from the temporally preceding value is considered.

4. The method according to claim 2, which further comprises comparing the value to the temporally preceding value.

5. The method according to claim 1, which further comprises outputting the value by means of an output device or is transmitted to the output device.

6. The method according to claim 1, wherein in that a hearing device wearer's speech and/or participation in a conversation is used as the ambient situation.

7. The method according to claim 1, which further comprises using a measure of background noise as the ambient situation.

8. A hearing device, comprising:
a microphone for detecting an ambient situation;
a signal processor connected to said microphone and programmed to:
receive the ambient situation;
assign a value to the ambient situation; and
use the value as a degree of adaptation.

9. A hearing device system, comprising:
a hearing device having a microphone for detecting an ambient situation and a signal processor programmed to receive the ambient situation, assign a value to the ambient situation, and use the value as a degree of adaptation; and
a smart phone having an output device, said hearing device and said smart phone are coupled via signaling technology, and the value generated by hearing device is output by means of said output device of said smart phone.

10. A computer program product, comprising:
a non-transitory computer-readable storage medium having computer-readable program code, the computer-readable program code containing instructions for carrying out a method for determining an adaptation to a hearing device by a hearing device wearer, the method including the steps of:
detecting an ambient situation;
assigning a value to the ambient situation; and
using the value as a degree of adaptation.
